(19) United States
(12) Patent Application Publication
(10) Pub. No.: US 2026/0188119 A1
(43) Pub. Date: Jul. 2, 2026

(54) Providing Parking Instructions based on Data Analysis

(71) Applicant: International Business Machines Corporation, Armonk, NY (US)

(72) Inventors: Xiao Xia Mao, Shanghai (CN); Tian Yu Wang, Shanghai (CN); Zhan Peng Huo, Beijing (CN); Wen Ya Zhou, Beijing (CN); Shu Hua Guo, Beijing (CN); Wei Jian Zang, Deqing (CN)

(21) Appl. No.: 19/007,670

(22) Filed: Jan. 2, 2025

(51) Int. Cl. G08G 1/14; B60W 30/06; B60W 50/14; B62D 15/02

(52) U.S. Cl. CPC G08G 1/143; B60W 30/06; B60W 50/14; B62D 15/028; B60W 2420/403; B60W 2710/18; B60W 2710/20

(57) ABSTRACT

Parking instructions is provided. A parking profile of a vehicle that is based on data corresponding to a parking area, the vehicle, a driver, and a plurality of sensors is sent to a remote server. The remote server generates a set of parking options in ranked order with specific parking instructions of each parking option for parking the vehicle in the parking area using the parking profile of the vehicle taking into account parking preferences and driving experience of the driver. The set of parking options is received in the ranked order with the specific parking instructions of each parking option for parking the vehicle in the parking area. The set of parking options is output in the ranked order with the specific parking instructions of each parking option for parking the vehicle in the parking area via a human interface for review by the driver.

### BACKGROUND

The disclosure relates generally to vehicles and more specifically to parking vehicles in parking areas.

Parking areas, such as parking garages, lots, or the like, are places for vehicle parking. Parking areas are needed in urban settings, suburban settings, and the like to accommodate all types of vehicles (e.g., commercial, residential, and public). Most parking areas are designed to maximize the number of parking spaces and, therefore, maximize the number of parked vehicles. A parking space is an individual space for one vehicle to park. Parking spaces are marked so that each vehicle can park in the designated marked space. Parking spaces can be arranged for angled parking, perpendicular parking, parallel parking, or any combination thereof.

### SUMMARY

According to one illustrative embodiment, a method is provided. A computer of a vehicle sends a parking profile of a vehicle that is based on data corresponding to a parking area, the vehicle, a driver, and a plurality of sensors to a remote server via a network. The remote server generates a set of parking options in ranked order with specific parking instructions of each parking option for parking the vehicle in the parking area using the parking profile of the vehicle taking into account parking preferences and driving experience of the driver. The computer of the vehicle receives the set of parking options in the ranked order with the specific parking instructions of each parking option for parking the vehicle in the parking area from the remote server via the network. The computer of the vehicle outputs the set of parking options in the ranked order with the specific parking instructions of each parking option for parking the vehicle in the parking area via a human interface for review by the driver. According to other illustrative embodiments, a computer system and computer program product are provided.

According to another illustrative embodiment, a computer-implemented method is provided. The computer-implemented method generates a set of parking options in ranked order with specific parking instructions of each parking option for parking a vehicle in a parking area using a parking profile of the vehicle. The computer-implemented method outputs the set of parking options in the ranked order with the specific parking instructions of each parking option for parking the vehicle in the parking area via a human interface of the vehicle.

### BRIEF DESCRIPTION OF THE DRAWINGS

FIG. 1 is a pictorial representation of a computing environment in which illustrative embodiments may be implemented;

FIGS. 2A-2B are a diagram illustrating an example of a vehicle parking system in accordance with an illustrative embodiment;

FIG. 3 is a diagram illustrating an example of one parking scenario in accordance with an illustrative embodiment;

FIG. 4 is a diagram illustrating an example of a second parking scenario in accordance with an illustrative embodiment;

FIG. 5 is a diagram illustrating an example of a third parking scenario in accordance with an illustrative embodiment;

FIG. 6 is a diagram illustrating an example of visual parking instructions in accordance with an illustrative embodiment;

FIG. 7 is a diagram illustrating an example of visual steering wheel angle instructions in accordance with an illustrative embodiment;

FIG. 8 is a diagram illustrating an example of a data structure in accordance with an illustrative embodiment; and

FIGS. 9A-9B are a flowchart illustrating a process for providing parking instructions based on data analysis in accordance with an illustrative embodiment.

### DETAILED DESCRIPTION

Various aspects of the present disclosure are described by narrative text,

flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A CPP embodiment is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

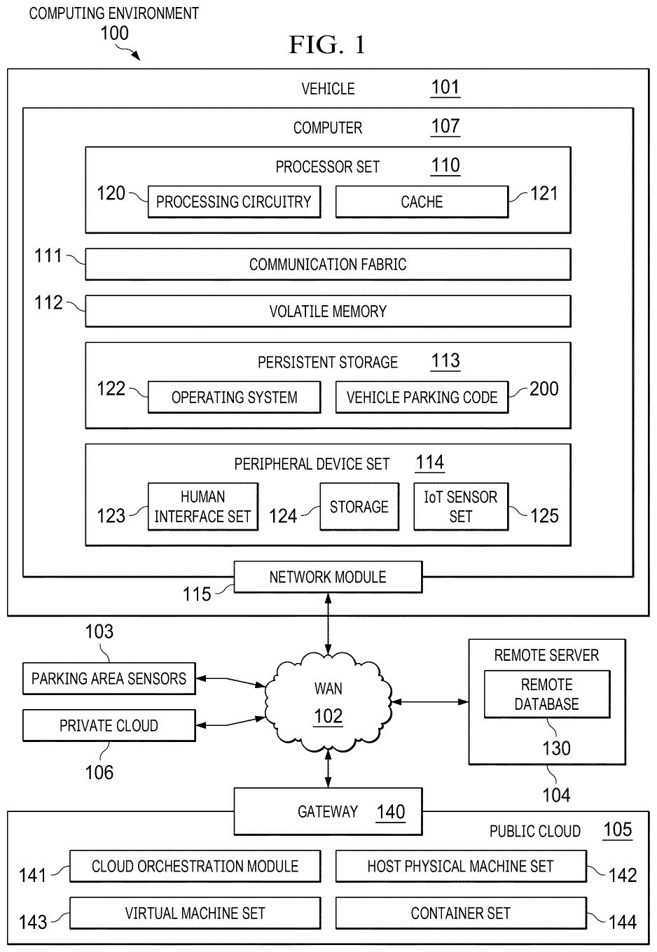

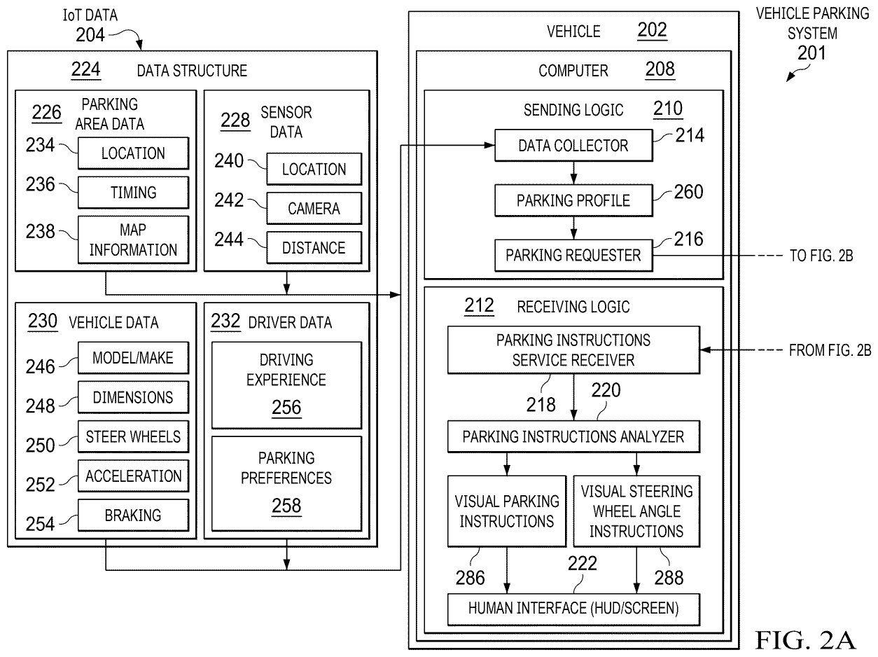

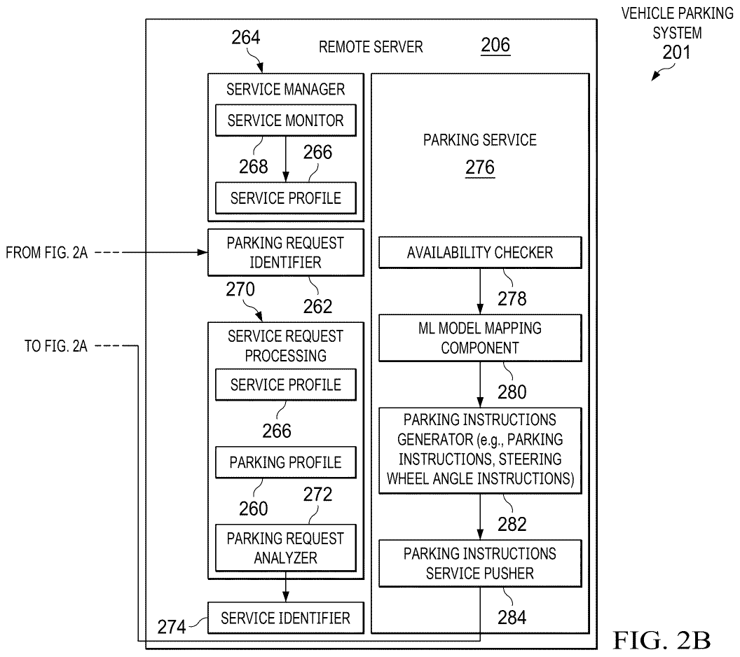

With reference now to the figures, and in particular, with reference to FIG. 1 and FIGS. 2A-2B, diagrams of data processing environments are provided in which illustrative embodiments may be implemented. It should be appreciated that FIG. 1 and FIGS. 2A-2B are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods of illustrative embodiments, such as vehicle parking code 200.

Vehicle parking code 200 generates at least one of visual parking instructions, visual steering wheel angle instructions, and audio instructions to assist a driver in parking a vehicle in a parking area, such as a parking garage or parking lot. Vehicle parking code 200 outputs the generated visual parking instructions, visual steering wheel angle instructions, and audio instructions to the driver via a human interface, such as, for example, a navigation system, display device, audio system, heads up display system, smart phone, or any combination thereof.

In addition to vehicle parking code 200, computing environment 100 includes, for example, vehicle 101, wide area network (WAN) 102, parking area sensors 103, remote server 104, public cloud 105, and private cloud 106. In this embodiment, vehicle 101 includes computer 107. Computer 107 includes, for example, processor set 110 (including processing circuitry 120 and cache 121), communication fabric 111, volatile memory 112, persistent storage 113 (including operating system 122 and vehicle parking code 200, as identified above), peripheral device set 114 (including human interface set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 107 may take the form of any computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 107, to keep the presentation as simple as possible.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.”

Computer-readable program instructions are typically loaded onto computer 107 to cause a series of operational steps to be performed by processor set 110 of computer 107 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in vehicle parking code 200 in persistent storage 113.

Communication fabric 111 is the signal conduction path that allows the various components of computer 107 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 107, the volatile memory 112 is located in a single package and is internal to computer 107, but, alternatively or additionally, the volatile memory may be distributed over multiple packages and/or located externally with respect to computer 107.

Persistent storage 113 is any form of non-volatile storage for computers that is now known or to be developed in the future. The non-volatility of this storage means that the stored data is maintained regardless of whether power is being supplied to computer 107 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel.

Peripheral device set 114 includes the set of peripheral devices of computer 107. Data communication connections between the peripheral devices and the other components of computer 107 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, human interface set 123 may include components such as a display screen, speaker, microphone, wearable devices (such as smart glasses, mixed reality devices, or the like), mouse, touchpad, navigation system, and audio system.

Storage 124 may be persistent and/or volatile. Storage 124 may be, for example, insertable storage, such as an SD card.

IoT sensor set 125 is made up of a plurality of sensors. For example, the plurality of sensors can include a set of cameras, motion sensors, velocity sensors, lateral acceleration sensors, inertial sensors, geographic location sensors, ultrasonic sensors, radar sensors, range finding sensors, infrared sensors, and the like.

Network module 115 is the collection of computer software, hardware, and firmware that allows computer 107 to communicate with other computers through WAN 102. Network module 115 may include hardware, such as Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 107 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

Parking area sensors 103 represent a collection of sensors located in and around a plurality of different parking areas or facilities. Parking area sensors 103 can include, for example, cameras, motion sensors, vehicle tracking sensors, and the like. Parking area sensors 103 are connected to WAN 102. As a result, computer 107 can retrieve real time information generated by parking area sensors 103 via WAN 102.

Remote server 104 is any computer system that serves at least some data and/or functionality to computer 107. Remote server 104 represents the machine(s) that collect and generate helpful and useful data for use by other computers, such as computer 107. For example, in a hypothetical case where remote server 104 is designed and programmed to generate vehicle parking instructions based on historical data, then this historical data may be provided to remote server 104 from remote database 130.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

Nowadays, vehicles (e.g., cars, sport utility vehicles, vans, trucks, and the like) have become essential for local and remote traveling needs of individuals and families. However, vehicle parking is a recurring issue for most drivers. For example, drivers on a daily basis may encounter challenging and technically demanding parking areas or facilities (e.g., parking garages, parking structures, parking lots, and the like). In addition, drivers may also encounter limited parking spaces, narrow pathways, steep inclines, sharp corners, improperly parked vehicles, and the like in these challenging parking areas. Even experienced drivers may have an accident or some type of vehicle damage (e.g., scratches) while trying to park in such parking areas, let alone drivers with limited driving and parking experience. As a result, vehicle parking may pose safety risks to people, vehicles, and parking area structures and equipment.

Existing vehicle navigation systems cannot provide precise real time navigation inside parking garages or support real time driving instructions when a vehicle is in an accident-prone position. Therefore, when encountering such parking areas or difficult parking situations, drivers need a solution that will assist the drivers while attempting to park in challenging parking areas or difficult parking situations. Illustrative embodiments provide parking instructions for parking a vehicle in parking areas based on real time data collection and analysis to avoid potential accident-prone locations within the parking area, thereby increasing vehicle safety.

Thus, illustrative embodiments provide one or more technical solutions that overcome a technical problem with an inability of existing solutions to provide real time parking instructions for parking vehicles in parking areas. As a result, these one or more technical solutions provide a technical effect and practical application in the field of vehicle safety.

With reference now to FIGS. 2A-2B, a diagram illustrating an example of a vehicle parking system is depicted in accordance with an illustrative embodiment. Vehicle parking system 201 may be implemented in a computing environment, such as computing environment 100 in FIG. 1. Vehicle parking system 201 is a system of hardware and software components for providing parking instructions based on data analysis. Vehicle parking system 201 provides the parking instructions by performing analysis of IoT data comprising parking area data, sensor data, vehicle data, and driver data to determine, for example, parking area layout and current parking space availability, vehicle dimensions and steering capabilities, driver parking preferences and historic parking experiences, and the like.

In this example, vehicle parking system 201 includes vehicle 202, IoT data 204, and remote server 206. Vehicle 202 may be, for example, vehicle 101 in FIG. 1. Remote server 206 may be, for example, remote server 104 in FIG. 1. However, it should be noted that vehicle parking system 201 is intended as an example only and not as a limitation on illustrative embodiments. For example, vehicle parking system 201 may include any number of vehicles, IoT data, remote servers, and other devices, components, and data not shown.

Vehicle 202 includes computer 208, such as computer 107 in FIG. 1. Computer 208 includes two major components, sending logic 210 and receiving logic 212. Sending logic 210 is comprised of data collector 214 and parking requester 216. Receiving logic 212 is comprised of parking instructions service receiver 218, parking instructions analyzer 220, and human interface 222.

Computer 208 of vehicle 202 utilizes data collector 214 to retrieve and record IoT data 204. Data collector 214 stores IoT data 204 in data structure 224. IoT data 204 include parking area data 226, sensor data 228, vehicle data 230, and driver data 232.

Parking area data 226 include location 234 identifying the geographic location of the parking area where the driver of vehicle 202 wants to park, timing 236 representing when the driver wants to park vehicle 202 and the parking conditions at that time, and map information 238 defining the layout of the parking area including locations of structures, equipment, obstacles, parking spaces, and the like. Sensor data 228 represent information collected from a plurality of different sensors, such as IoT sensor set 125 and parking area sensors 103 in FIG. 1. Sensor data 228 include, for example, current location 240 of vehicle 202, images from camera 242, and distance 244 identifying the distance between vehicle 202 and structures, obstacles, and other vehicles within the parking area. Camera 242 represents a plurality of cameras and other imaging capturing devices. For example, camera 242 can represent a set of cameras located on vehicle 202 and a set of cameras located in and around the parking area. Further, camera 242 can represent a camera in a cellular or smart phone of the driver.

Vehicle data 230 represent information obtained from, for example, the manufacturer, owner's manual, online sources, and the like that corresponds to vehicle 202. In this example, vehicle data 230 include vehicle make and model 246, dimensions 248, steering wheels 250 identifying the amount or degree of steering wheel turning needed to turn the vehicle at a certain angle or degree (e.g., mapping degree of steering wheel turning to degree of vehicle front wheels turning), acceleration 252 identifying the speed needed for parking, and braking 254 identifying an amount of braking needed during parking. Driver data 232 is obtained from the driver of vehicle 202. Driver data 232 include, for example, driving experience 256, parking preferences 258, previous parking experience, and the like.

Data collector 214 generates parking profile 260 for vehicle 202 based on IoT data 204. Computer 208 uses parking requester 216 to generate a parking request based on parking profile 260 of vehicle 202. Parking requester 216 sends the parking request that includes the information in parking profile 260 to parking request identifier 262 on remote server 206. Remote server 206 provides a smart parking instructions service.

Remote server 206 uses service manager 264 to generate service profile 266 via service monitor 268 based on the parking request received from vehicle 202. Service manager 264 coordinates the operation of the other components providing the smart parking instructions service of remote server 206. In parking request identifier 262, each service instance is an agent of parking requester 216. Each service instance implements service request processing 270 on remote server 206. Service request processing 270 includes parking request analyzer 272 that analyzes parking profile 260 generated by data collector 214 and service profile 266 generated by service manager 264 to find a matching service identifier 274. Remote server 206 utilizes service identifier 274 to identify a vehicle profile corresponding to the service request received from vehicle 202 for parking vehicle 202 in the parking area.

In service identifier 274, each service instance is an agent of parking service 276 of remote server 206. Parking service 276 includes availability checker 278, machine learning model mapping component 280, parking instructions generator 282, and parking instructions service pusher 284.

Availability checker 278 identifies all available parking spaces in the parking area. Machine leaning model mapping component 280 maps the service request to a particular vehicle profile corresponding to vehicle 202 for parking. Parking instructions generator 282 generates the parking instructions (e.g., maneuvering instructions, steering wheel angle instructions, and the like) for a selected parking space in the parking area based on the vehicle profile. Parking instructions generator 282 sends the parking instructions to parking instructions service receiver 218 of computer 208 via parking instructions service pusher 284.

However, in alternative illustrative embodiments, one or more components of remote server 206 (e.g., parking request analyzer, availability checker 278, and parking instructions generator 282) can be implemented in computer 208 of vehicle 202 in addition to, or instead of, remote server 206. As a result, in the alternative illustrative embodiments, computer 208, itself, can implement the smart parking instructions service by generating the parking instructions without using remote server 206.

Parking instructions service receiver 218 forwards the parking instructions to parking instructions analyzer 220 of computer 208. Parking instructions analyzer 220 generates visual parking instructions 286 and visual steering wheel angle instructions 288 for display to the driver of vehicle 202 based on the received parking instructions. Visual parking instructions 286 and visual steering wheel angle instructions 288 may be, for example, a set of graphics, images, videos, or any combination thereof to guide the driver in safely parking vehicle 202. Parking instructions analyzer 220 displays visual parking instructions 286 and visual steering wheel angle instructions 288 to the driver via human interface 222 (e.g., a display screen, heads up display, or the like). Human interface 222 may also include an audio system for outputting computer-generated speech instructions to the driver. In addition, the driver can enable computer 208 to automatically park vehicle 202 in the selected parking space in the parking area based on displayed visual parking instructions 286 and visual steering wheel angle instructions 288.

In an alternative illustrative embodiment, parking instructions generator 282 may generate a ranked list of parking space options, with an optimal parking space option listed at the top to reduce driver decisions regarding the parking process. Parking instructions analyzer 220 then displays the ranked list of parking space options in descending order, along with accident-prone areas near each parking space option in the parking area, accident-prone parts of vehicle 202 corresponding to different parking space options, and the like.

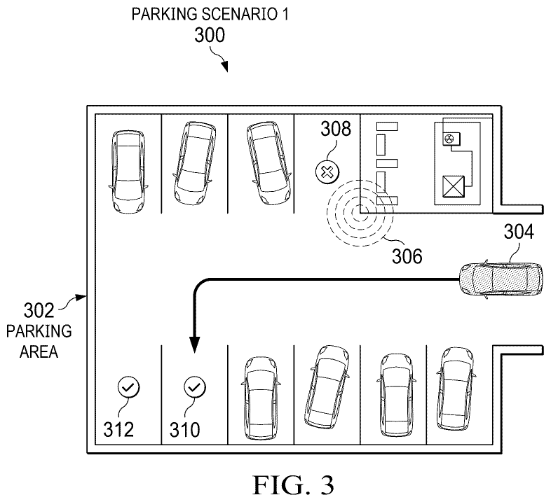

With reference now to FIG. 3, a diagram illustrating an example of one parking scenario is depicted in accordance with an illustrative embodiment. Parking scenario 1 300 depicts parking area 302 and vehicle 304. Vehicle 304 may be, for example, vehicle 101 in FIG. 1 or vehicle 202 in FIG. 2A.

Based on real time parking conditions in parking area 302, illustrative embodiments prioritize or rank parking options according to how safe, accessible, and convenient each parking option is for the driver to park vehicle 304 in parking area 302. In this example, illustrative embodiments avoid accident-prone area 306 near parking space 308 and select parking space 310 next to empty parking space 312 as the optimal parking option.

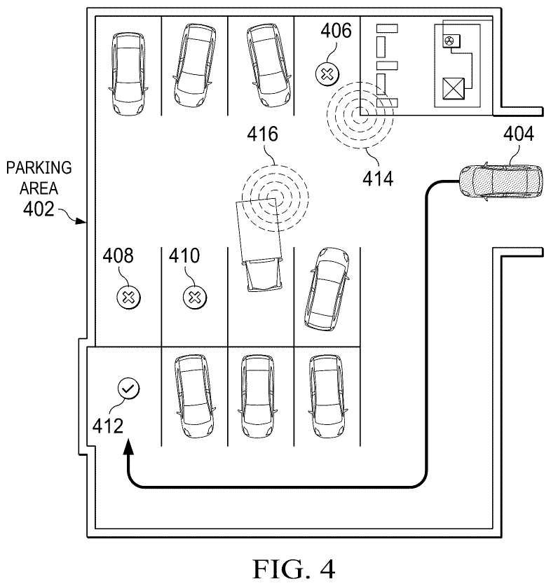

With reference now to FIG. 4, a diagram illustrating an example of a second parking scenario is depicted in accordance with an illustrative embodiment. Parking scenario 2 400 depicts parking area 402 and vehicle 404.

In this example, multiple parking spaces, such as parking space 406, parking space 408, parking space 410, and parking space 412, are currently available in parking area 402. However, due to accident-prone area 414 and accident-prone area 416, illustrative embodiments do not select parking spaces 406, 408, or 410 as a parking option. Instead, illustrative embodiments select parking space 412 as the optimal parking option having the lowest risk factor and a pathway with no obstacles and more room to maneuver. Thus, illustrative embodiments give priority to safe and easily accessible parking spaces.

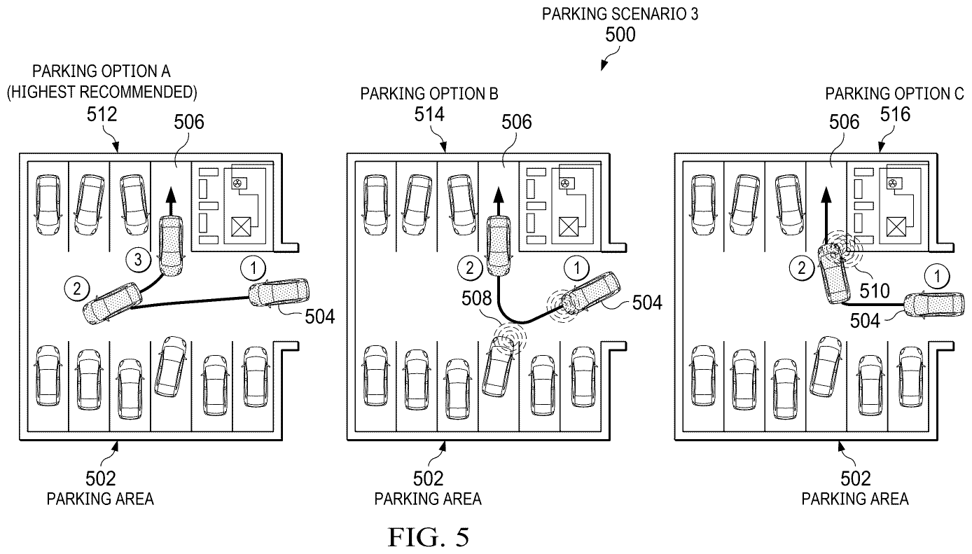

With reference now to FIG. 5, a diagram illustrating an example of a third parking scenario is depicted in accordance with an illustrative embodiment. Parking scenario 3 500 depicts parking area 502 and vehicle 504.

In this example, illustrative embodiments identify that only one parking space, parking space 506, is currently available for vehicle 504 to park in parking area 502. In addition, illustrative embodiments identify accident-prone area 508 within parking area 502 due to an improperly parked vehicle and accident-prone area 510 due to a sharp corner.

In response to identifying accident-prone area 508 and accident-prone area 510 within parking area 502, illustrative embodiments generate multiple parking options, such as parking option A 512, parking option B 514, and parking option C 516, in ranked order based on historical parking experience, driving experience, and parking preferences of the driver. In this example, parking option A 512 is the most accessible, obstacle-free, and preference-compliant pathway to parking space 506. Illustrative embodiments can highlight the different pathways corresponding to the different parking options, while showing each of the accident-prone areas.

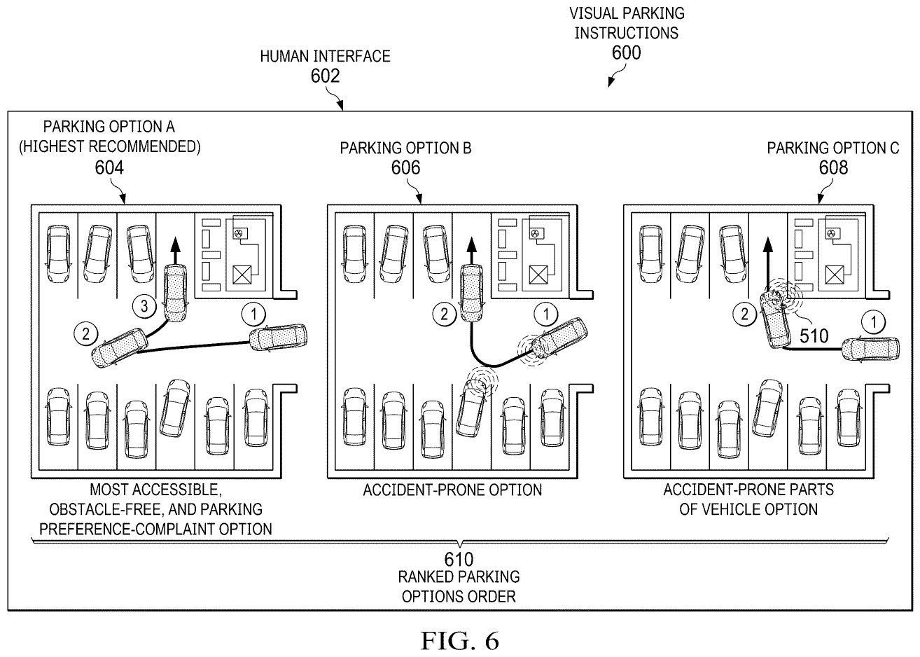

With reference now to FIG. 6, a diagram illustrating an example of visual parking instructions is depicted in accordance with an illustrative embodiment. Visual parking instructions 600 may be, for example, visual parking instructions 286 in FIG. 2A. Visual parking instructions 600 are generated by a parking instructions analyzer, such as parking instructions analyzer 220 in computer 208 of vehicle 202 in FIG. 2A.

The parking instructions analyzer outputs visual parking instructions 600 in human interface 602 for driver review and selection. Human interface 602 may be, for example, human interface 222 in FIG. 2A.

In this example, the parking instructions analyzer displays parking option A 604, parking option B 606, and parking option C 608 in human interface 602. In each parking option, the parking instructions analyzer highlights the optimal parking pathway, any accident-prone area associated with a particular parking option, and any accident-prone parts of the vehicle while parking in a particular parking space. For example, parking option A 604 is the optimal parking option because parking option A 604 is the most accessible, obstacle-free, and parking preference-compliant option. Parking option B 606 is an accident-prone option due to an improperly parked vehicle. Parking option C 608 is an accident-prone part of the vehicle option due to a sharp corner next to the parking space. The parking instructions analyzer 220 displays parking option A 604, parking option B 606, and parking option C 608 in ranked parking options order 610 from highest recommended to least recommended option.

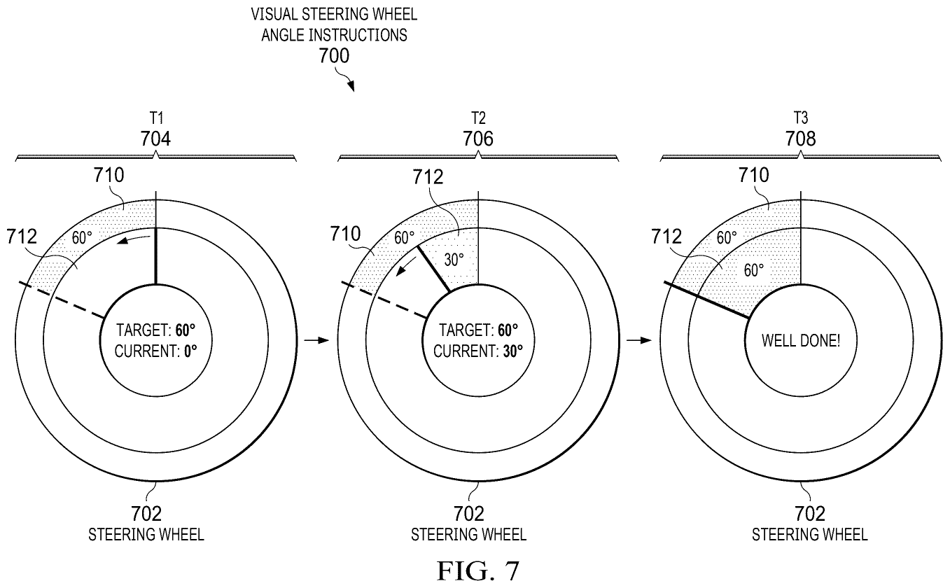

With reference now to FIG. 7, a diagram illustrating an example of visual steering wheel angle instructions is depicted in accordance with an illustrative embodiment. Visual steering wheel angle instructions 700 may be, for example, visual steering wheel angle instructions 288 in FIG. 2A. Visual steering wheel angle instructions 700 are generated by a parking instructions analyzer, such as parking instructions analyzer 220 in computer 208 of vehicle 202 in FIG. 2A.

Visual steering wheel angle instructions 700 depict steering wheel 702, which corresponds to a vehicle parking in a parking area, at time T1 704, time T2 706, and time T3 708. Time T1 704, time T2 706, and time T3 708 provide a series of data visualizations for the driver to calibrate the parking maneuver.

In this example, visual steering wheel angle instructions 700 at time T1 704, time T2 706, and time T3 708 show optimal steering wheel angle target 710 to be 60 degrees to the left, which is the correct angle for steering wheel 702 to have a corresponding front wheel alignment for safe and proper parking of the vehicle in a parking space. However, at time T1 704, current actual steering wheel angle 712 is 0 degrees. At time T2 706, current actual steering wheel angle 712 is at 30 degrees moving toward the optimal steering wheel angle target of 60 degrees. Then, at time T3 708, current actual steering wheel angle 712 is at 60 degrees matching the optimal steering wheel angle target.

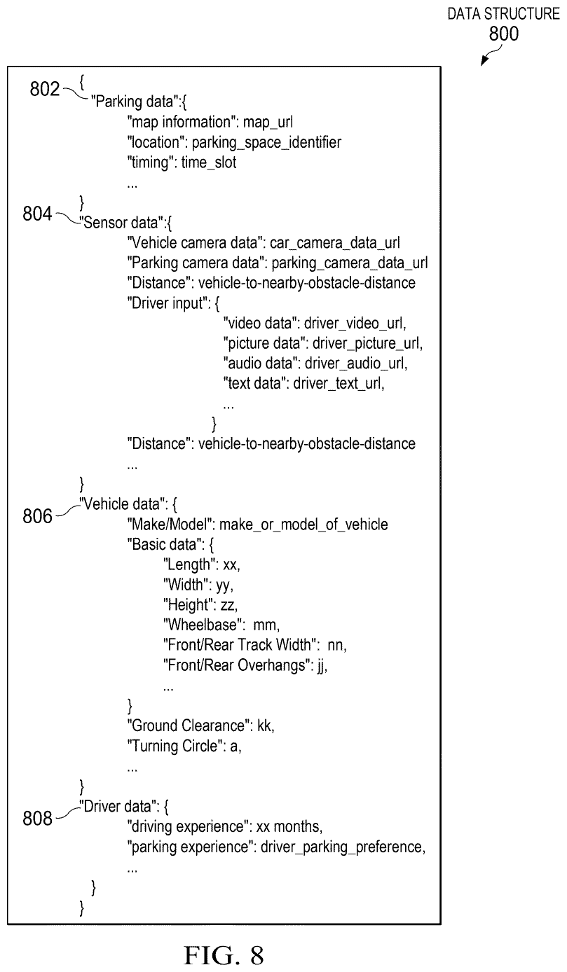

With reference now to FIG. 8, a diagram illustrating an example of a data structure is depicted in accordance with an illustrative embodiment. Data structure 800 may be, for example, data structure 224 in FIG. 2A. Data structure 800 is implemented in a vehicle computer, such as computer 208 of vehicle 202 in FIG. 2A. In this example, data structure 800 includes parking data 802, sensor data 804, vehicle data 806, and driver data 808. However, it should be noted that data structure 800 is intended as an example only and may include more or less information than shown.

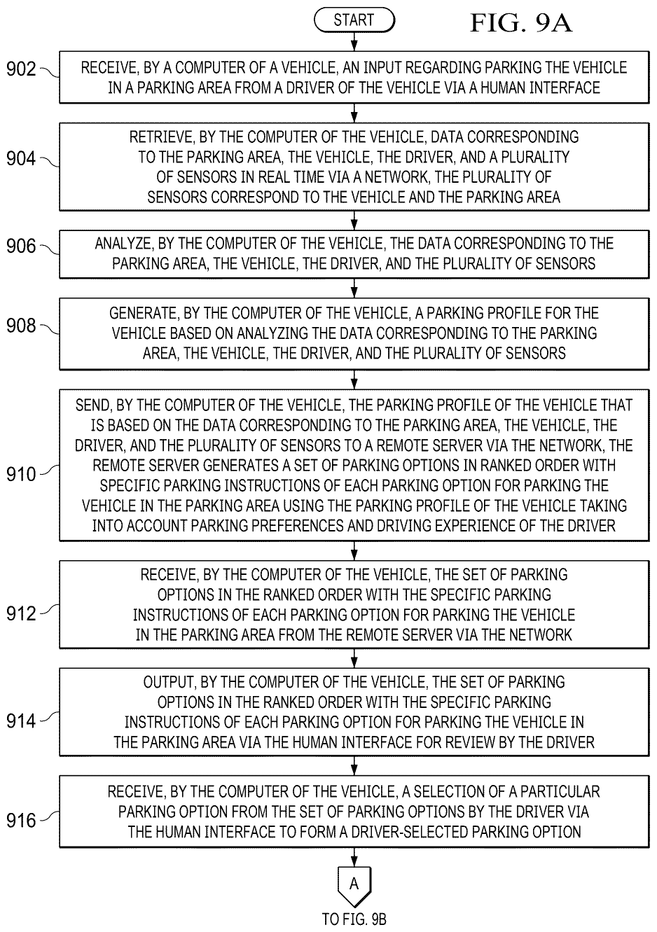

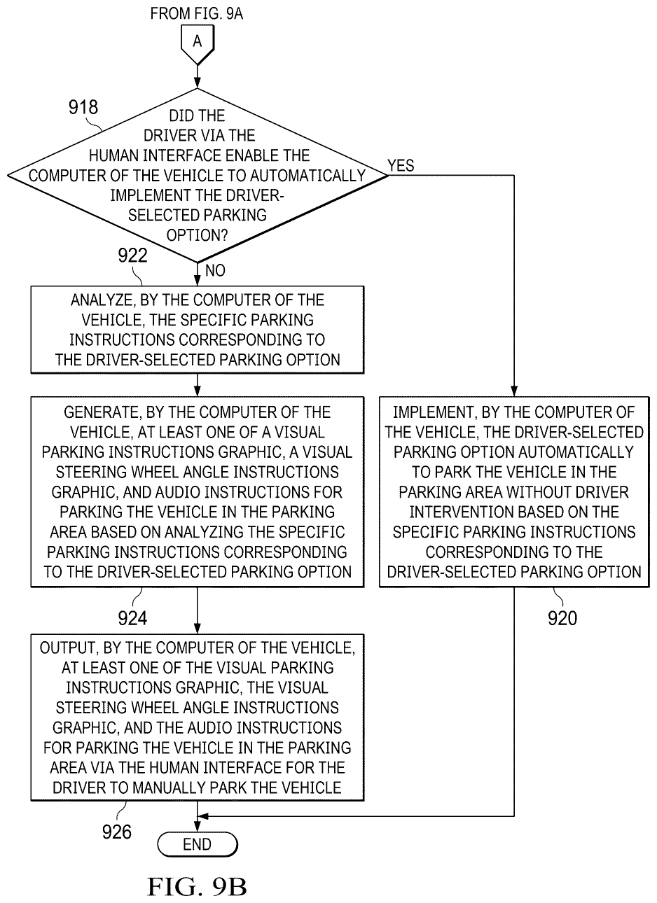

With reference now to FIGS. 9A-9B, a flowchart illustrating a process for providing parking instructions based on data analysis is shown in accordance with an illustrative embodiment. The process shown in FIGS. 9A-9B may be implemented in a computer, such as, for example, computer 107 in FIG. 1 or computer 208 in FIG. 2A. For example, the process shown in FIGS. 9A-9B may be implemented by vehicle parking code 200 in FIG. 1.

The process begins when the computer of a vehicle receives an input regarding parking the vehicle in a parking area from a driver of the vehicle via a human interface (step 902). In response to receiving the input, the computer of the vehicle retrieves data corresponding to the parking area, the vehicle, the driver, and a plurality of sensors in real time via a network (step 904). The plurality of sensors correspond to the vehicle and the parking area.

The computer of the vehicle analyzes the data corresponding to the parking area, the vehicle, the driver, and the plurality of sensors (step 906). The computer of the vehicle generates a parking profile for the vehicle based on analyzing the data corresponding to the parking area, the vehicle, the driver, and the plurality of sensors (step 908).

The computer of the vehicle sends the parking profile of the vehicle that is based on the data corresponding to the parking area, the vehicle, the driver, and the plurality of sensors to a remote server via the network (step 910). The remote server generates a set of parking options in ranked order with specific parking instructions of each parking option for parking the vehicle in the parking area using the parking profile of the vehicle taking into account parking preferences and driving experience of the driver.

The computer of the vehicle receives the set of parking options in the ranked order with the specific parking instructions of each parking option for parking the vehicle in the parking area from the remote server via the network (step 912). The computer of the vehicle outputs the set of parking options in the ranked order with the specific parking instructions of each parking option for parking the vehicle in the parking area via the human interface for review by the driver (step 914).

Subsequently, the computer of the vehicle receives a selection of a particular parking option from the set of parking options by the driver via the human interface to form a driver-selected parking option (step 916). Afterward, the computer of the vehicle makes a determination as to whether the driver via the human interface enabled the computer of the vehicle to automatically implement the driver-selected parking option (step 918). If the computer of the vehicle determines that the driver via the human interface did enable the computer of the vehicle to automatically implement the driver-selected parking option, yes output of step 918, then the computer of the vehicle automatically implements the driver-selected parking option to park the vehicle in the parking area without driver intervention based on the specific parking instructions corresponding to the driver-selected parking option (step 920). Thereafter, the process terminates.

If the computer of the vehicle determines that the driver via the human interface did not enable the computer of the vehicle to automatically implement the driver-selected parking option, no output of step 918, then the computer of the vehicle analyzes the specific parking instructions corresponding to the driver-selected parking option (step 922). The computer of the vehicle generates at least one of a visual parking instructions graphic, a visual steering wheel angle instructions graphic, and audio instructions for parking the vehicle in the parking area based on analyzing the specific parking instructions corresponding to the driver-selected parking option (step 924). The computer of the vehicle outputs at least one of the visual parking instructions graphic, the visual steering wheel angle instructions graphic, and the audio instructions for parking the vehicle in the parking area via the human interface for the driver to manually park the vehicle (step 926). Thereafter, the process terminates.

Thus, illustrative embodiments of the present disclosure provide a computer-implemented method, computer system, and computer program product for providing parking instructions based on data analysis. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
sending, by a computer of a vehicle, a parking profile of a vehicle that is based on data corresponding to a parking area, the vehicle, a driver, and a plurality of sensors to a remote server via a network, the remote server generates a set of parking options in ranked order with specific parking instructions of each parking option for parking the vehicle in the parking area using the parking profile of the vehicle taking into account parking preferences and driving experience of the driver;
receiving, by the computer of the vehicle, the set of parking options in the ranked order with the specific parking instructions of each parking option for parking the vehicle in the parking area from the remote server via the network; and
outputting, by the computer of the vehicle, the set of parking options in the ranked order with the specific parking instructions of each parking option for parking the vehicle in the parking area via a human interface for review by the driver.

2. The method of claim 1, further comprising:
receiving, by the computer of the vehicle, a selection of a particular parking option from the set of parking options by the driver via the human interface to form a driver-selected parking option; and
determining, by the computer of the vehicle, whether the driver via the human interface enabled the computer of the vehicle to automatically implement the driver-selected parking option.

3. The method of claim 2, further comprising:
responsive to the computer of the vehicle determining that the driver via the human interface did not enable the computer of the vehicle to automatically implement the driver-selected parking option, analyzing, by the computer of the vehicle, the specific parking instructions corresponding to the driver-selected parking option;
generating, by the computer of the vehicle, at least one of a visual parking instructions graphic, a visual steering wheel angle instructions graphic, and audio instructions for parking the vehicle in the parking area based on analyzing the specific parking instructions corresponding to the driver-selected parking option; and
outputting, by the computer of the vehicle, at least one of the visual parking instructions graphic, the visual steering wheel angle instructions graphic, and the audio instructions for parking the vehicle in the parking area via the human interface for the driver to manually park the vehicle.

4. The method of claim 2, further comprising:
responsive to the computer of the vehicle determining that the driver via the human interface did enable the computer of the vehicle to automatically implement the driver-selected parking option, implementing, by the computer of the vehicle, the driver-selected parking option automatically to park the vehicle in the parking area without driver intervention based on the specific parking instructions corresponding to the driver-selected parking option.

5. The method of claim 1, further comprising:
receiving, by the computer of the vehicle, an input regarding parking the vehicle in the parking area from the driver of the vehicle via the human interface; and
retrieving, by the computer of the vehicle, data corresponding to the parking area, the vehicle, the driver, and the plurality of sensors in real time via the network in response to receiving the input, the plurality of sensors correspond to the vehicle and the parking area.

6. The method of claim 1, further comprising:
analyzing, by the computer of the vehicle, the data corresponding to the parking area, the vehicle, the driver, and the plurality of sensors; and
generating, by the computer of the vehicle, the parking profile for the vehicle based on analyzing the data corresponding to the parking area, the vehicle, the driver, and the plurality of sensors.

7. The method of claim 1, wherein the data corresponding to the parking area include geographic location of the parking area where the driver of the vehicle wants to park, time when the driver wants to park the vehicle at the parking area, parking conditions at that time, and map information defining layout of the parking area, and wherein the data corresponding to the plurality of sensors include current location of the vehicle, images from cameras corresponding to the vehicle and the parking area, and distance between the vehicle and structures, obstacles, and other vehicles within the parking area, and wherein the data corresponding to the vehicle include make and model of the vehicle, dimensions of the vehicle, steering wheels information identifying an amount of steering wheel turning needed to turn the vehicle at a certain angle, acceleration information identifying speed needed for parking, and braking information identifying an amount of braking needed during parking, and wherein the data corresponding to the driver include driving experience, parking preferences, and previous parking experience of the driver.

8. A computer system comprising:
a processor set;
one or more computer-readable storage media; and
program instructions stored on the one or more computer-readable storage media to cause the processor set to perform operations comprising:
sending, by a computer of a vehicle, a parking profile of a vehicle that is based on data corresponding to a parking area, the vehicle, a driver, and a plurality of sensors to a remote server via a network, the remote server generates a set of parking options in ranked order with specific parking instructions of each parking option for parking the vehicle in the parking area using the parking profile of the vehicle taking into account parking preferences and driving experience of the driver;
receiving, by the computer of the vehicle, the set of parking options in the ranked order with the specific parking instructions of each parking option for parking the vehicle in the parking area from the remote server via the network; and
outputting, by the computer of the vehicle, the set of parking options in the ranked order with the specific parking instructions of each parking option for parking the vehicle in the parking area via a human interface for review by the driver.

9. The computer system of claim 8, wherein the operations further comprise:
receiving, by the computer of the vehicle, a selection of a particular parking option from the set of parking options by the driver via the human interface to form a driver-selected parking option; and
determining, by the computer of the vehicle, whether the driver via the human interface enabled the computer of the vehicle to automatically implement the driver-selected parking option.

10. The computer system of claim 9, wherein the operations further comprise:
responsive to the computer of the vehicle determining that the driver via the human interface did not enable the computer of the vehicle to automatically implement the driver-selected parking option, analyzing, by the computer of the vehicle, the specific parking instructions corresponding to the driver-selected parking option;
generating, by the computer of the vehicle, at least one of a visual parking instructions graphic, a visual steering wheel angle instructions graphic, and audio instructions for parking the vehicle in the parking area based on analyzing the specific parking instructions corresponding to the driver-selected parking option; and
outputting, by the computer of the vehicle, at least one of the visual parking instructions graphic, the visual steering wheel angle instructions graphic, and the audio instructions for parking the vehicle in the parking area via the human interface for the driver to manually park the vehicle.

11. The computer system of claim 9, wherein the operations further comprise:
responsive to the computer of the vehicle determining that the driver via the human interface did enable the computer of the vehicle to automatically implement the driver-selected parking option, implementing, by the computer of the vehicle, the driver-selected parking option automatically to park the vehicle in the parking area without driver intervention based on the specific parking instructions corresponding to the driver-selected parking option.

12. The computer system of claim 8, wherein the operations further comprise:
receiving, by the computer of the vehicle, an input regarding parking the vehicle in the parking area from the driver of the vehicle via the human interface; and
retrieving, by the computer of the vehicle, data corresponding to the parking area, the vehicle, the driver, and the plurality of sensors in real time via the network in response to receiving the input, the plurality of sensors correspond to the vehicle and the parking area.

13. The computer system of claim 8, wherein the operations further comprise:
analyzing, by the computer of the vehicle, the data corresponding to the parking area, the vehicle, the driver, and the plurality of sensors; and
generating, by the computer of the vehicle, the parking profile for the vehicle based on analyzing the data corresponding to the parking area, the vehicle, the driver, and the plurality of sensors.

14. The computer system of claim 8, wherein the data corresponding to the parking area include geographic location of the parking area where the driver of the vehicle wants to park, time when the driver wants to park the vehicle at the parking area, parking conditions at that time, and map information defining layout of the parking area, and wherein the data corresponding to the plurality of sensors include current location of the vehicle, images from cameras corresponding to the vehicle and the parking area, and distance between the vehicle and structures, obstacles, and other vehicles within the parking area, and wherein the data corresponding to the vehicle include make and model of the vehicle, dimensions of the vehicle, steering wheels information identifying an amount of steering wheel turning needed to turn the vehicle at a certain angle, acceleration information identifying speed needed for parking, and braking information identifying an amount of braking needed during parking, and wherein the data corresponding to the driver include driving experience, parking preferences, and previous parking experience of the driver.

15. A computer program product comprising:
one or more computer-readable storage media; and
program instructions stored on the one or more computer-readable storage media to perform operations comprising:
sending, by a computer of a vehicle, a parking profile of a vehicle that is based on data corresponding to a parking area, the vehicle, a driver, and a plurality of sensors to a remote server via a network, the remote server generates a set of parking options in ranked order with specific parking instructions of each parking option for parking the vehicle in the parking area using the parking profile of the vehicle taking into account parking preferences and driving experience of the driver;
receiving, by the computer of the vehicle, the set of parking options in the ranked order with the specific parking instructions of each parking option for parking the vehicle in the parking area from the remote server via the network; and
outputting, by the computer of the vehicle, the set of parking options in the ranked order with the specific parking instructions of each parking option for parking the vehicle in the parking area via a human interface for review by the driver.

16. The computer program product of claim 15, wherein the operations further comprise:
receiving, by the computer of the vehicle, a selection of a particular parking option from the set of parking options by the driver via the human interface to form a driver-selected parking option; and
determining, by the computer of the vehicle, whether the driver via the human interface enabled the computer of the vehicle to automatically implement the driver-selected parking option.

17. The computer program product of claim 16, wherein the operations further comprise:
responsive to the computer of the vehicle determining that the driver via the human interface did not enable the computer of the vehicle to automatically implement the driver-selected parking option, analyzing, by the computer of the vehicle, the specific parking instructions corresponding to the driver-selected parking option;
generating, by the computer of the vehicle, at least one of a visual parking instructions graphic, a visual steering wheel angle instructions graphic, and audio instructions for parking the vehicle in the parking area based on analyzing the specific parking instructions corresponding to the driver-selected parking option; and
outputting, by the computer of the vehicle, at least one of the visual parking instructions graphic, the visual steering wheel angle instructions graphic, and the audio instructions for parking the vehicle in the parking area via the human interface for the driver to manually park the vehicle.

18. The computer program product of claim 16, wherein the operations further comprise:
responsive to the computer of the vehicle determining that the driver via the human interface did enable the computer of the vehicle to automatically implement the driver-selected parking option, implementing, by the computer of the vehicle, the driver-selected parking option automatically to park the vehicle in the parking area without driver intervention based on the specific parking instructions corresponding to the driver-selected parking option.

19. The computer program product of claim 15, wherein the operations further comprise:
receiving, by the computer of the vehicle, an input regarding parking the vehicle in the parking area from the driver of the vehicle via the human interface; and
retrieving, by the computer of the vehicle, data corresponding to the parking area, the vehicle, the driver, and the plurality of sensors in real time via the network in response to receiving the input, the plurality of sensors correspond to the vehicle and the parking area.

20. The computer program product of claim 15, wherein the operations further comprise:
analyzing, by the computer of the vehicle, the data corresponding to the parking area, the vehicle, the driver, and the plurality of sensors; and
generating, by the computer of the vehicle, the parking profile for the vehicle based on analyzing the data corresponding to the parking area, the vehicle, the driver, and the plurality of sensors.

21. The computer program product of claim 15, wherein the data corresponding to the parking area include geographic location of the parking area where the driver of the vehicle wants to park, time when the driver wants to park the vehicle at the parking area, parking conditions at that time, and map information defining layout of the parking area, and wherein the data corresponding to the plurality of sensors include current location of the vehicle, images from cameras corresponding to the vehicle and the parking area, and distance between the vehicle and structures, obstacles, and other vehicles within the parking area, and wherein the data corresponding to the vehicle include make and model of the vehicle, dimensions of the vehicle, steering wheels information identifying an amount of steering wheel turning needed to turn the vehicle at a certain angle, acceleration information identifying speed needed for parking, and braking information identifying an amount of braking needed during parking, and wherein the data corresponding to the driver include driving experience, parking preferences, and previous parking experience of the driver.

22. A computer-implemented method comprising:
generating a set of parking options in ranked order with specific parking instructions of each parking option for parking a vehicle in a parking area using a parking profile of the vehicle; and
outputting the set of parking options in the ranked order with the specific parking instructions of each parking option for parking the vehicle in the parking area via a human interface of the vehicle.

23. The computer-implemented method of claim 22, further comprising:
receiving a selection of a particular parking option from the set of parking options by a driver via the human interface; and
determining whether the driver via the human interface enabled a computer of the vehicle to automatically implement that particular parking option selected by the driver.

24. The computer-implemented method of claim 23, further comprising:
responsive to determining that the driver did not enable the computer of the vehicle to automatically implement that particular parking option selected by the driver, analyzing the specific parking instructions corresponding to that particular parking option selected by the driver;
generating a visual parking instructions graphic, a visual steering wheel angle instructions graphic, and audio instructions for parking the vehicle in the parking area based on analyzing the specific parking instructions corresponding to that particular parking option selected by the driver; and
outputting the visual parking instructions graphic, the visual steering wheel angle instructions graphic, and the audio instructions for parking the vehicle in the parking area via the human interface.

25. The computer-implemented method of claim 23, further comprising:
responsive to determining that the driver did enable the computer of the vehicle to automatically implement that particular parking option selected by the driver, implementing that particular parking option selected by the driver automatically to park the vehicle in the parking area based on the specific parking instructions corresponding to that particular parking option selected by the driver.
